(19) United States
(12) Patent Application Publication
(10) Pub. No.: US 2020/0129942 A1
(43) Pub. Date: Apr. 30, 2020

(54) LOW COST PLATE REACTOR FOR EXOTHERMIC REACTIONS

(71) Applicant: IH IP Holdings Limited, St. Helier (JE)

(72) Inventors: Joseph A. Murray, Raleigh, NC (US); Julie A. Morris, Flower Mound, TX (US); Tushar Tank, Raleigh, NC (US); Hector Alejandro Rosa, Raleigh, NC (US); Melissa Brent Hill, Raleigh, NC (US)

(21) Appl. No.: 16/703,323

(22) Filed: Dec. 4, 2019

Related U.S. Application Data
(63) Continuation of application No. PCT/US18/36392, filed on Jun. 7, 2018.
(60) Provisional application No. 62/516,846, filed on Jun. 8, 2017.

(51) Int. Cl. B01J 3/04; B01J 3/03; B01J 19/08

(52) U.S. Cl. CPC B01J 3/04; B01J 3/03; B01J 2219/0286; B01J 2219/00135; B01J 2219/1923; B01J 19/088

(57) ABSTRACT

A low cost and versatile plate reactor is capable of producing exothermic reactions under a wide variety of conditions using a wide variety of materials. The reactor design can be used to test various combinations of materials and triggers for exothermic reactions quickly. The reactor design can be used for solid-state materials, wet-cells/electrolytic materials, plasmas, and gases. The design will work with nanoparticles, solid materials, materials plated to a reactor wall, heavy water, or other liquid materials, and gases.

### CROSS-REFERENCE TO RELATED APPLICATIONS

This application is a continuation of International Application No. PCT/US18/36392, filed on Jun. 7, 2018, entitled “LOW COST PLATE REACTOR FOR EXOTHERMIC REACTIONS,” which claims priority U.S. Provisional Patent Application Ser. No. 62/516,846, filed on Jun. 8, 2017 and entitled “LOW COST PLATE REACTOR FOR EXOTHERMIC REACTIONS.”

### TECHNICAL FIELD

The present disclosure relates generally to the field of exothermic reaction systems and, more particularly, to a low cost plate reactor for use in producing exothermic reactions under a wide variety of condition and using a wide variety of materials.

### BACKGROUND

Over the past 30 years, scientists have observed the phenomena of excess heat being generated when a transition metal or metal alloy such as palladium, nickel or platinum, is exposed to hydrogen gas, or one of its isotopes under pressure. This phenomena is known as a low energy nuclear reaction (LENR). While much research is being conducted to better understand the LENR phenomena, LENR technology is not developed to the point of being commercially viable. Therefore, there is a need for further research to develop commercially viable reaction systems.

A great deal of the current research is focused on identifying the combination of materials and triggering conditions needed to cause and sustain exothermic reactions. Researchers test a variety of theories, ranging from solid state reactors with pressure or magnetic triggers to wet electrolytic cells with voltage triggers and more. Most researchers develop their own costly test reactors specially designed for their unique requirements. These reactors meet various requirements, dealing with the materials under test, triggers such as vacuum, pressure, voltage, etc, and calorimetry measurements.

One common reactor design is a stainless steel cylinder with a resistive heating wire wrapped around the cylinder. A material of interest is placed inside the reactor. AC voltage is sent through the wire and turned on and off. Calorimetry is performed by using a thermal camera and a second unfueled reactor as a control.

Another common reactor design is the electrolytic wet seal. A metal is suspended in heavy water with a wire, typically platinum, creating a coil around the metal. Voltage and ground are applied to the appropriate electrodes. Magnet triggers or other triggers can be placed outside the wet seal. calorimetry is typically performed using thermocouples suspended in the heavy water, and by measuring the voltage and current applied to the electrodes.

Other reactors use nanoparticles in a container. The container must be able to hold a vacuum and be heated. Hydrogen or deuterium is quickly flowed into the container to trigger the reaction. calorimetry is performed by reading pressure and thermocouple temperatures.

A final example of an existing reactor technology is a small clamshell that contains a cartridge heater and space for fuel. The clamshell is placed in an insulated space, either by using an insulation material or vacuum. A dirichlet boundary is created to surround the clamshell and insulation. A port communicates with the interior of the clamshell to provide the ability to create a vacuum or to add gas. Temperature is cycled using the cartridge heater. calorimetry includes thermocouple measurements, power going to the heaters, temperature of the boundary, and more.

Each of these reactor technologies is specific to its own material, triggering mechanism, and calorimetry requirements. Because the reactor and triggering is unique in each case, the cost of equipment increases due to low volume and specific measurement requirements, including the range of the measurement, sampling rate, number of channels, etc. Some of the reactors have special vacuum and pressure requirements. Adding measurements for calorimetry into a vacuum or pressurized environment adds special restrictions and cost to the equipment. Increasing the number of ports adds to complexity and the opportunity for leaks.

Due to the high cost and complexity to build test reactor systems, only a handful of each system exists. Since an experiment may take days to weeks to run, it is impractical to test many variations in material, trigger, etc, quickly. This limitation greatly limits the researcher's ability to collect data and results needed to narrow down the best combination of materials and triggers for producing exothermic reactions. If the researchers decides to change triggers, they must start from the beginning with a different reactor design. This makes quickly analyzing a variety of combinations very cost and time prohibitive, and thus holds back the progress of exothermic reaction technology.

### SUMMARY

The present disclosure relates to a low cost and versatile reaction system for producing exothermic reactions under a wide variety of conditions using a wide variety of materials. The reactor design according to embodiments of the disclosure can be used to test various combinations of fuel materials and triggers for exothermic reactions quickly. The reactor design can be used for testing solid-state materials, wet-seals/electrolytic materials, gases, and plasma. The design will work with nanoparticles, solid materials, materials plated to a reactor wall, heavy water, or other liquid materials, and gases.

The low cost and versatile reactor is made using two or more plates configured to be assembled together. Each plate includes a cavity configured such that when the plates are assembled together, the cavities collectively form a reaction chamber. The reaction chamber is sealed by one or more seals. Each seal is disposed between a respective pair of the plates and surrounds the reaction chamber to seal the reaction chamber. A gas port is formed in at least one of the plates for supplying gas to or evacuating gas from the reaction chamber while the plates are assembled.

The reactor can be outfitted with various triggers to prepare and/or activate exothermic reactions, including but not limited to voltage, magnetics, high temperature, vacuum, high pressure, or a combination of these. The reactor is designed to accommodate various types of temperature and/or pressure sensors. Power supplied to feeders, magnetic coils, or other triggering devices can be measured. The reactor can be placed in a temperature controlled chamber, in a vacuum chamber, covered in insulation, and/or placed in a heat flow calorimeter. Virtually any method the researcher wants to use for calorimetry calculations can be accommodated.

Due to the low cost of the reactor system and instrumentation, many experiments can be set up and run in parallel. Thus, it is possible to conduct a greater number of experiments to test more combinations of materials and triggers.

### BRIEF DESCRIPTION OF THE DRAWINGS

FIG. 1 is a perspective view of an exemplary reactor comprising a top plate and bottom plate.

FIGS. 2 and 3 are exploded perspective views of the exemplary reactor shown in FIG. 1.

FIGS. 4 and 5 illustrate an alternate top plate for the reactor shown in FIG. 1.

FIG. 6 shows a design variation for the reactor shown in FIG. 1.

FIG. 7 is a section view showing a alternate seal design.

FIG. 8 illustrates a reactor including an expansion plate between the top plate and bottom plate.

FIG. 9 illustrates a multi-plate reactor having heat transfer fins.

### DETAILED DESCRIPTION

Referring now to the drawings, exemplary embodiments of the exothermic reactor 10 are shown. Throughout the specification and drawings, similar elements in the exemplary embodiments are indicated by similar reference numbers.

In general, the exothermic reactor 10 comprises a reactor housing 12 made from two or more plates that are stacked together. Each plate includes a cavity configured so that, when the plates are stacked together, a reaction chamber is formed inside the reactor housing 12. Fuel materials to be tested are placed into the reactor cavity. The reactor housing 12 is constructed of a material that can sustain high temperatures, vacuum, and/or high pressure, such as stainless steel. The material for the reactor housing 12 also should not react with the fuel materials of interest. For reactors where low thermal conductivity is desired, materials such as stainless steel, nickel alloys (e.g., Inconel, Incoloy), or titanium may be used. Where high thermal conductivity is desired, materials such as aluminum alloys, copper alloys, and silver alloys can be used. Aluminum alloys are better suited for heat sink applications but have low strength and a relatively low melting point. Copper alloys have higher melting points and offer good corrosion resistance, but may not be suited for the certain fuel materials. Silver alloys have higher melting points than aluminum alloys and are not implicated in contamination of exothermic reactions, but would be more expensive. If strength is a concern, coatings with high thermal conductivity, e.g., DLC, could be used in conjunction with lower thermal conductivity materials that provide better strength.

In one embodiment, the reactor housing 12 may be generally in the form of a box that is 3″×3″×3″. Stainless steel is a strong metal that does not react with typical reactor materials and can withstand the high temperatures that some triggers require. Stainless steel also allows magnetics through at about the same permeability as air, which is required for some reactions. In addition, stainless steel is relatively low cost and readily available. It can also be machined which helps to keep costs low.

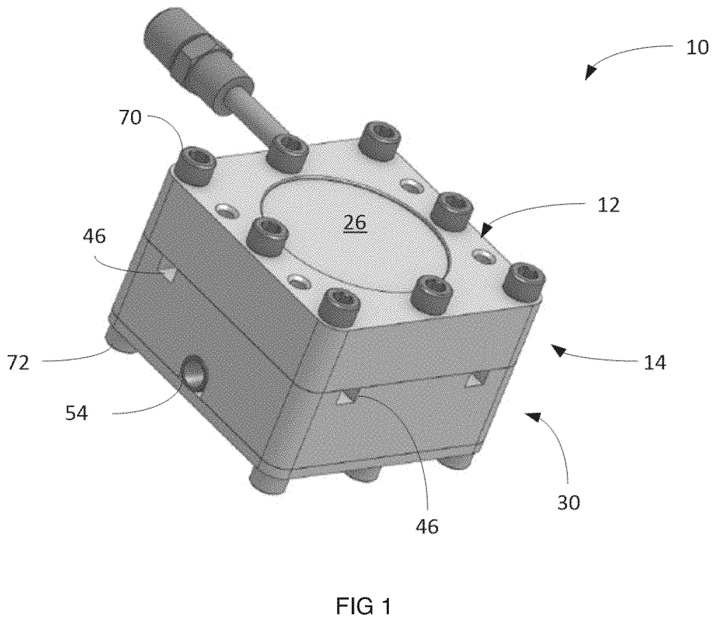

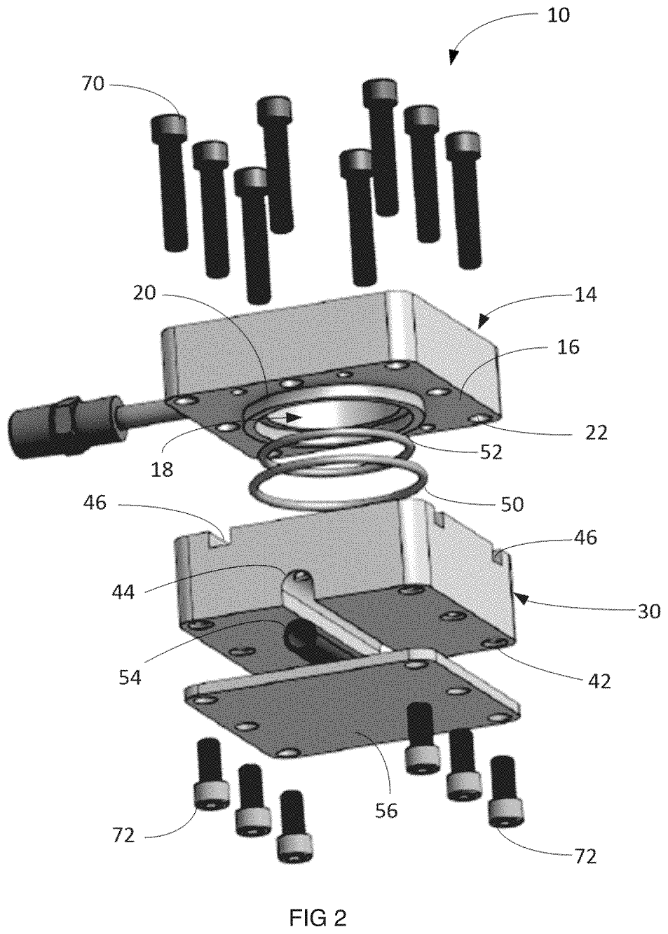

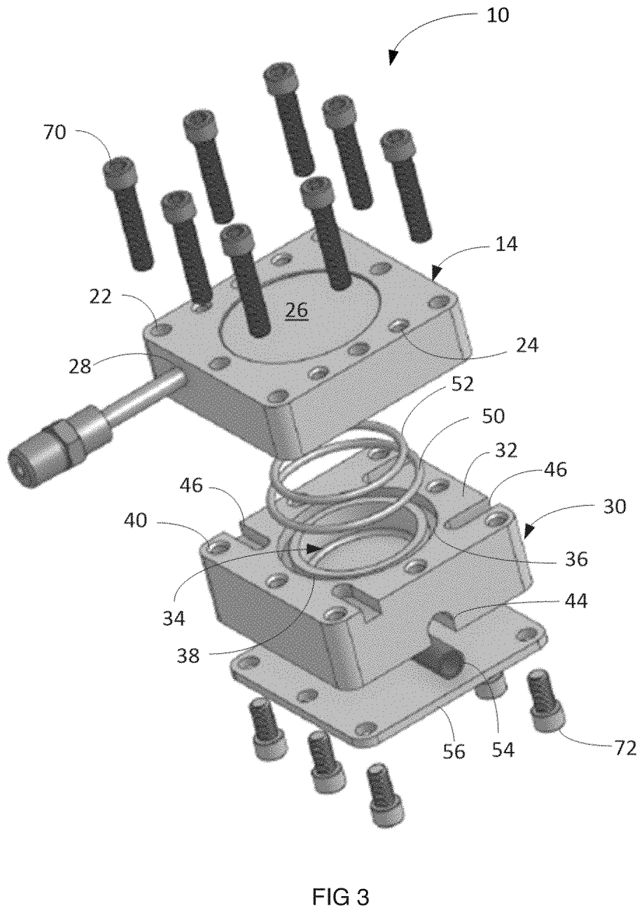

FIGS. 1-3 illustrate an exemplary reactor 10 wherein the reactor housing 12 is made of two plates: a top plate 14 and a bottom plate 30. The top plate 14 includes a contact surface 16 that engages a contact surface 32 on the bottom plate 30 when the top plate 14 and bottom plate 30 are assembled together. The top and bottom plates 14, 30 each include a cavity, 18 and 34 respectively, that form the reaction chamber when the top and bottom plates are assembled.

The top plate 14 includes a circular wall 20 that surrounds the cavity 18 and projects downwardly from the contact surface 16. The bottom plate 30 includes a circular groove 36 that receives the circular wall 20 of the top plate 14 when the top and bottom plates 14, 30 are assembled. The bottom plate 30 further includes a recessed surface 38 that surrounds the cavity 34 and is concentrically arranged with the recessed groove 36. Before the plates 14, 30 are assembled, a first seal 50 is placed in the recessed groove 36 on the bottom plate 30, and a second seal 52 is placed on the recessed surface 38. When the top and bottom plates 14 and 30 are assembled, the seals 50, 52 are compressed between the top and bottom plates 14, 30 to seal the reaction chamber. Vacuum seals or high pressure seals may be used depending on the particular application. When a high pressure environment in the reaction chamber is required, the inner seal 52 may comprise a high pressure seal and the outer seal 50 may comprise a vacuum seal. In order to create a vacuum in the reaction chamber, the inner seal 52 may comprise a vacuum seal and the outer seal 50 may comprise a high pressure seal. In some embodiments, the inner seal 52 may comprise a seal rated for both vacuum and high pressure and the outer seal 50 can be omitted.

The top and bottom plates 14, 30 may be secured together by threaded bolts 70. In this case, the top plate 14 includes a series of through holes 22 and the bottom plate 30 includes a series of bolt holes 40 that are aligned with the through holes in the top plate 14. The threaded bolts are inserted through the through holes 22 in the top plate 14 and threaded into the threaded holes 40 in the bottom plate 30 to secure the plates together. In the embodiment shown in FIGS. 1-3, the top plate 14 further includes a set of threaded jacking holes 24 for separating the top and bottom plates 14, 30. The jacking holes 24 align with the contact surface 32 on the bottom plate 30 so that when a jacking screw (not shown) is threaded into the jacking holes 24, the ends of the jacking screw push against the contact surface 34 on the bottom plate 30 to push the top and bottom plates 14, 30 apart.

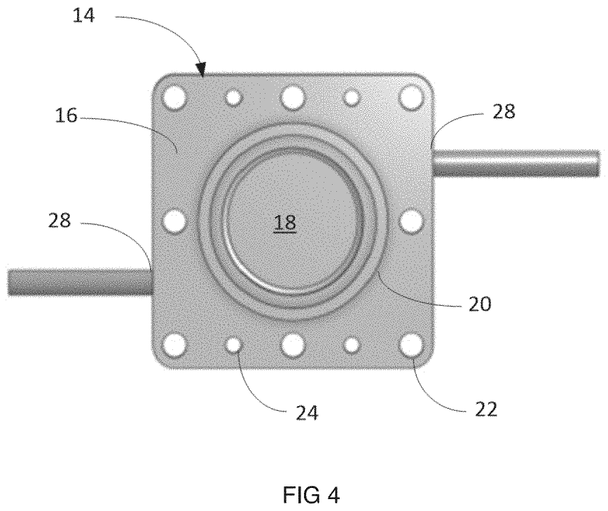

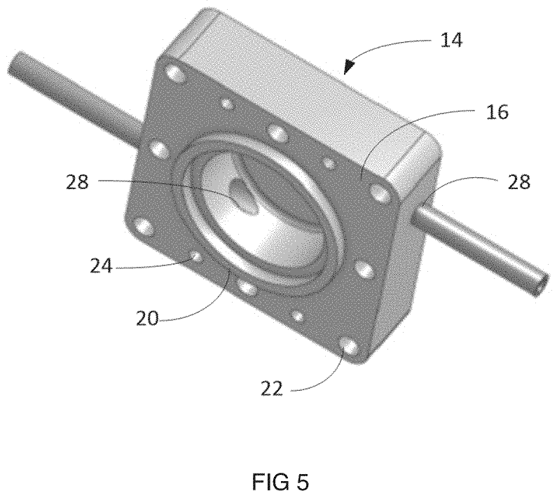

A variety of holes or recesses can be formed in the top and bottom plates 14, 16 to accommodate various sensors components depending on the reaction system that is needed. In the embodiment shown in FIGS. 1-3, a gas port 28 is formed in the top plate 14 and communicates with the cavity 18 in the top plate 14. The gas port 28 can be connected to a vacuum or to a gas source depending on the experiment. As noted above, the seals 50, 52 can be interchanged depending on the operating environment inside the reaction chamber so that both a high pressure environment and vacuum can be achieved. The gas port 28 also allows gas to be captured before and after an experiment. Additional gas ports 28 can be provided as needed. For example, FIGS. 4 and 5 illustrate an alternate design for the top plate 14 having two gas ports 28. The presence of two gas ports 28 allows for the flow of fluid through the reaction chamber. For example, in a plasma-based system, two gas ports 28 may be used to allow a gas flow across the reaction chamber. In a nanoparticle-based system, only one gas port may be necessary. An electrolytic-based system may utilize one or more gas ports.

For certain experiments, high temperature may be required. In the embodiment shown in FIGS. 1-3, the bottom plate 30 includes a channel 44 to receive a heating element 54. The heating element 54 is held in place by a mounting plate 56 that bolts to the bottom surface of the bottom plate 30. For this purpose, the bottom plate 30 includes a series of mounting holes 42 into which mounting screws 72 are threaded. The mounting holes 42 may also be used to mount various types of instrumentation to the bottom of the reactor housing 12.

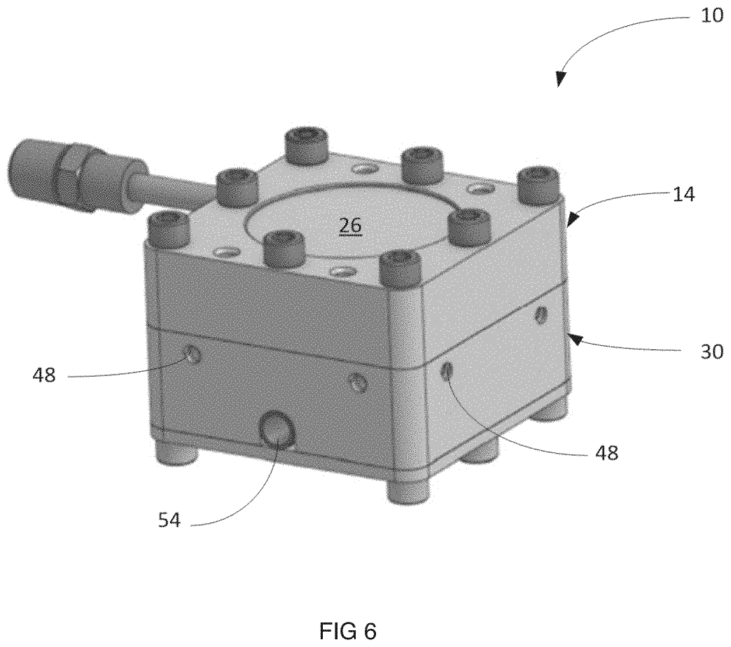

The reactor design shown in FIGS. 1-3 further includes milled slots 46 formed in the bottom plate 30. The milled slots 46 may be used to accommodate various temperature measuring devices such as thermocouples, thermistors, or RTDs, depending on the desired temperature range and precision. The temperature measuring devices may be used for calorimetry. FIG. 6 shows an alternate design for the bottom plate 30 wherein threaded holes 48 are formed in the bottom plate 30 in place of the milled slots 46. The threaded holes 48 may be configured to allow insertion of RTDs for higher precision and temperature measurement. The milled slots 46 for thermocouples, as depicted in FIGS. 1-3, may be used for higher temperature applications when the temperature is out of the range of an RTD.

The reactor housing 12 may be modified to accommodate various types of triggers. In one embodiment, a recessed area 26 is formed in the top surface of the top plate 14. As shown in FIG. 1, the recessed area 26 is generally circular in form and is configured so that a coil can be placed on the top of the reactor housing 12 if the researcher wants to use a magnetic trigger. The coil can be held in place using the jacking holes 24 as mounting points. In other embodiments, coils may be placed on the bottom of the reactor housing using the mounting holes 42.

For a voltage trigger, a small hole (not shown) can be drilled from the top surface of the top plate 14 into the cavity 18. An electrode (not shown) can be inserted into a sleeve made of fiberglass or other suitable sealing material and then inserted into the hole so that it extends into the reaction chamber. The fiberglass sleeve serves to create a solid seal. Voltage can be applied to the electrode to trigger the exothermic reactor.

The reactor 10 is versatile in design so that it can accommodate a wide variety of reaction materials. Dry material, such as nanoparticles, foils, or plated metal, can be placed in the reaction chamber. Wet material, such as heavy water, or a suspended metal in a liquid electrode, can also be used. The material can be placed in the reaction chamber prior to the assembly of the top and bottom plates 14, 30. Once assembled, air can be evacuated via gas port 28. Process gas, such as argon, deuterium, or hydrogen, may be supplied via the gas port 28.

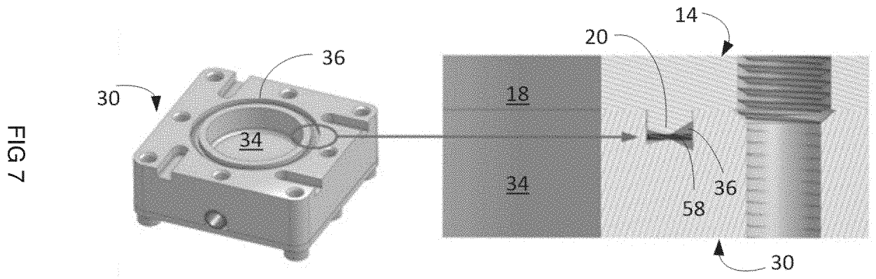

FIG. 7 illustrates an alternate design for sealing the reaction chamber. The top plate 14 includes a circular wall 20 as previously described and the bottom plate 30 includes a circular groove 36. The circular wall 20 and circular groove 36 are machined with cutting edges to allow use of a conflat style of seal 58. When the plates 14 and 30 are pressed together, the cutting edges on the circular wall 20 and in the groove 36 cut into a gasket to form a seal.

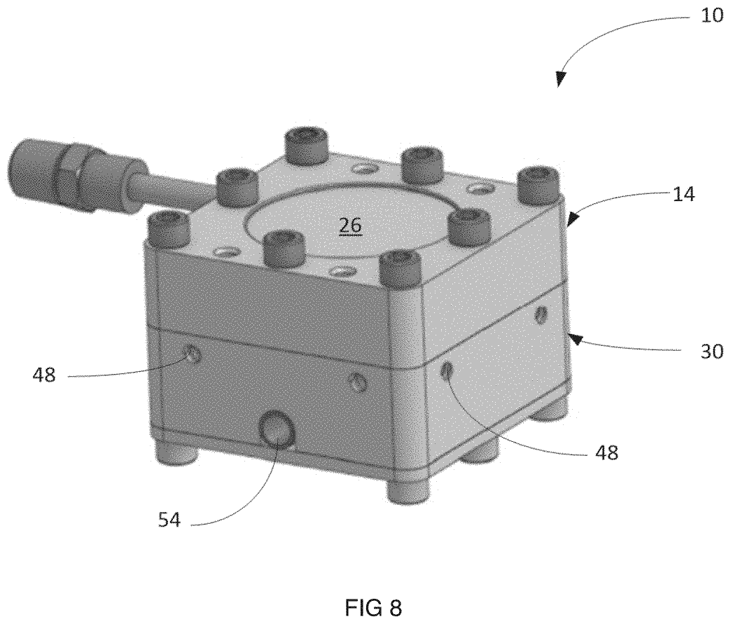

FIG. 8 illustrates an embodiment of the reactor 10 with an expansion plate 60 between the top plate 14 and bottom plate 30. The expansion plate 60 includes a first contact surface that engages the contact surface 16 on the top plate 14 and a second contact surface that engages the contact surface 32 on the bottom plate 30. A cavity is formed in the expansion plate 60 which, together with the cavities 18, 34 in the top and bottom plates 14, 30, form a reaction chamber. Any number of expansion plates 60 could be used depending on the size requirements for the reaction chamber. The same sealing methods as previously described may be used between the expansion plate 60 and top plate 14, and between the expansion plate 60 and bottom plate 30. The expansion plate 60 may include features such as gas ports, channels for heating elements, and openings for sensors.

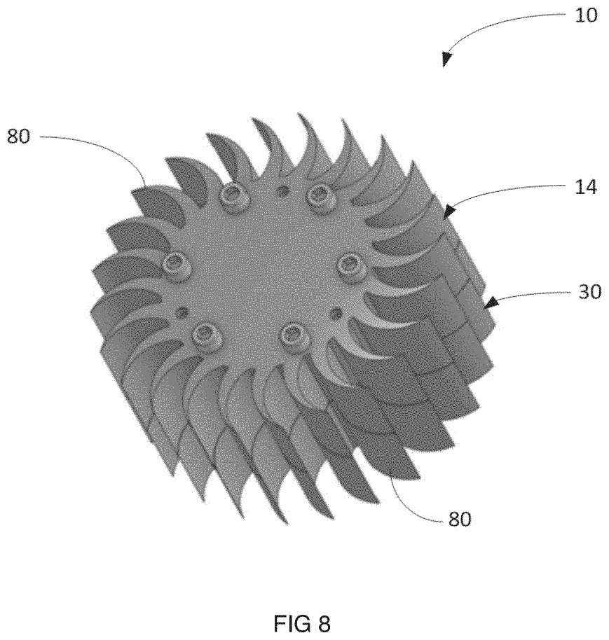

FIG. 9 illustrates another embodiment of the reactor 10 where the top and bottom plates 14, 30 include fins 80 to maximize heat transfer. For minimal heat transfer, the design depicted in FIG. 1 may be utilized.

System measurements can be achieved in a cost effective manner, using a variety of methods. Voltage and current measurements, which may need to be sampled at higher rates, can be achieved by using small processing boards, such as an Arduino, Galileo, RedPitaya, or similar boards. Many shields or extensions exist to allow measurements to be taken, such as the Rascal Precision Voltage board. Pre-assembled boards, such as the LabJack 77 are slightly more expensive, but still a cost effective solution.

Other measurements, such as temperature and pressure, which can be sampled at lower rates, can be measured by off-the-shelf PLCs with modular cards. Using off-the-shelf components offers a cost effective way to obtain measurements for storage or transmission over communication networks for remote storage. Other pre-assembled solutions can also be used, such as the LabJack T7 or National Instruments boards.

Data can be stored locally at each device, or can be sent over a communication channel, such as an Ethernet network, RS232, or Modbus, to a central server that can sync and store data. The data acquisition system can be modified to meet the needs of the reactor 10 and triggers under test. Due to the low cost of the equipment needed for data acquisition and collection, the data acquisition system does not prohibit the researcher from performing many tests in parallel. The server can also act as a central hub for a user to control operating parameters of the test system such as temperature, pressure, timing, etc.

Calorimetry can be achieved by taking measurements while the system is placed in a temperature controlled thermal chamber, a vacuum chamber, a heat flow calorimeter, or many other methods that can be determined by the researcher. The reactor 10 can also be insulated. Additional sensors can be added or removed the system.

What is claimed is:

1. An exothermic reactor comprising:
a reactor housing comprising at least two plates configured to be assembled together, each plate of the reactor housing including a cavity configured such that when the plates are assembled together, the cavities collectively form a reaction chamber;
one or more seals, each seal disposed between a respective pair of the plates and surrounding the reaction chamber to seal the reaction chamber; and
a first gas port in at least one of the plates of the reactor housing for supplying gas to or evacuating gas from the reaction chamber while the plates are assembled.

2. The exothermic reactor of claim 1 wherein the one or more seals includes a high pressure seal.

3. The exothermic reactor of claim 1 wherein the one or more seals comprises a vacuum seal or a conflat seal.

4. The exothermic reactor of claim 1, further comprising one or more temperature sensors.

5. The exothermic reactor of claim 4, further comprising a sensor cavity formed in at least one of the plates and configured to receive the temperature sensor.

6. The exothermic reactor of claim 5 wherein:
the temperature sensor comprises a thermocouple or thermistor; and
the sensor cavity comprises a slot extending to an outer surface of one of the plates and configured to receive the thermocouple or thermistor.

7. The exothermic reactor of claim 5 wherein:
the temperature sensor comprises a resistive temperature detector (RTD); and
the sensor cavity comprises a threaded opening extending to an outer surface of one of the plates and configured to receive the RTD.

8. The exothermic reactor of claim 1, comprising a triggering mechanism for triggering an exothermic reaction in the reaction chamber.

9. The exothermic reactor of claim 8 wherein:
the triggering mechanism comprises a magnetic coil; and
one of the plates further comprises a recessed seat configured to receive the magnetic coil.

10. The exothermic reactor of claim 9 wherein:
the triggering mechanism comprises an electrode; and
one of the plates further comprises a bore extending from an exterior surface of one of the plates to the reaction chamber to receive the electrode.

11. The exothermic reactor of claim 1, further comprising at least one heating element for heating the reaction chamber.

12. The exothermic reactor of claim 11, further comprising a heating cavity in one of the plates to receive the heating element.

13. The exothermic reactor of claim 1, further comprising a pressure sensor configured to measure the pressure within the reaction chamber.

14. The exothermic reactor of claim 1, comprising two concentric seals, an inner seal and an outer seal, disposed between a respective pair of the reaction plates and surrounding the reaction chamber to seal the reaction chamber.

15. The exothermic reactor of claim 14 wherein the inner seal comprises a high pressure seal and the outer seal comprises a vacuum seal.

16. The exothermic reactor of claim 14 wherein the inner seal comprises a vacuum seal and the outer seal comprises a high pressure seal.

17. The exothermic reactor of any one of claim 1, further comprising:
a set of through bores formed in one of the plates;
a set of threaded bolt holes formed in a second one of the plates and aligned with the through bores; and
one or more threaded bolts extending through corresponding through holes in the first one of the plates and threading into the bolt holes in the second one of the plates to secure the plates together.

18. The exothermic reactor of claim 1, further comprising a second set of threaded jacking holes in one of the plates extending from an outer surface of one of the plates and aligned with a contact surface on a second one of the plates for jacking the plates apart.

19. The exothermic reactor of claim 1, further comprising one or more threaded mounting holes on an exterior surface of one of the plates for mounting triggering devices or measuring devices to the reactor housing.

20. The exothermic reactor of claim 1, wherein the plates include a top plate, a bottom plate and at least one expansion plate disposed between the top and bottom plates, wherein the top plate, bottom plate and, one or more expansion plates each include a cavity that forms a part of the reaction chamber when the plates are assembled together.

21. A method of initiating an exothermic reaction comprising:
placing a fuel source within an exothermic reaction chamber of an exothermic reactor, wherein the exothermic reactor comprises:
a reactor housing comprising at least two plates configured to be assembled together, each plate of the reactor housing including a cavity configured such that when the plates are assembled together, the cavities collectively form a reaction chamber;
one or more seals, each seal disposed between a respective pair of the plates and surrounding the reaction chamber to seal the reaction chamber; and
a first gas port in at least one of the plates of the reactor housing for supplying gas to or evacuating gas from the reaction chamber while the plates are assembled;
supplying gas or evacuating gas from the reaction chamber; and
measuring one or more characteristics of the reaction.
